(19) United States
(12) Patent Application Publication
(10) Pub. No.: US 2026/0196634 A1
(43) Pub. Date: Jul. 9, 2026

(54) CASE ASSEMBLY AND BATTERY MODULE INCLUDING THE SAME

(71) Applicant: SK ON CO., LTD., Seoul (KR)

(72) Inventors: Ji Sang YOON, Daejeon (KR); In Seob KANG, Daejeon (KR); Dae Hyeon LEE, Daejeon (KR)

(21) Appl. No.: 19/441,851

(22) Filed: Jan. 7, 2026

(30) Foreign Application Priority Data
Jan. 7, 2025 (KR) 10-2025-0002468

(51) Int. Cl. H01M 50/262; H01M 50/244

(52) U.S. Cl. CPC H01M 50/262; H01M 50/244

(57) ABSTRACT

A case assembly according to one embodiment of the present disclosure includes a pair of main cases forming a peripheral portion of the case assembly; a front case forming a front face of the case assembly; and a rear case forming a rear face of the case assembly, wherein the pair of main cases have the same shape.

### DESCRIPTION

### CROSS-REFERENCE TO RELATED APPLICATION

This patent application claims the priority and benefits of Korean patent application No. 10-2025-0002468, filed on January 7, 2025, the disclosure of which is incorporated herein by reference in its entirety.

### BACKGROUND OF THE INVENTION

### 1. Field of the Invention

The present disclosure relates to a case assembly and a battery module including the same.

### 2. Description of the Related Art

In the manufacturing process of a battery module that accommodates a cell assembly, the battery case, which forms an exterior of the battery module, is assembled in various ways.

For example, to seat the cell assembly inside a battery case having a U shape, a sufficient inner width of the battery case should be secured. In addition, if the inner width of the battery case is at its lower limit or the cell assembly is at its upper limit, the assembly performance of the battery module may be affected.

### SUMMARY OF THE INVENTION

An object of the present disclosure is to provide a case assembly that facilitates seating of a cell assembly and a battery module including the same.

A case assembly configured to accommodate a cell assembly according to various embodiments of the present disclosure may include: a pair of main cases forming a peripheral portion of the case assembly; a front case forming a front face of the case assembly; and a rear case forming a rear face of the case assembly, wherein the pair of main cases may have the same shape.

In exemplary embodiments, the pair of main cases may include: a first case; and a second case coupled to the first case, wherein the first case and the second case may be symmetrical with respect to the cell assembly.

In exemplary embodiments, each of the first case and the second case may include a bent shape.

In exemplary embodiments, each of the first case and the second case may has an L-shape.

In exemplary embodiments, each of the first case and the second case may includes a C-shape.

In exemplary embodiments, the first case and the second case may be symmetrical with respect to a first reference plane, and a distance between the first reference plane and a left lateral face of the case assembly may be equal to a distance between the first reference plane and a right lateral face of the case assembly.

In exemplary embodiments, the first case and the second case may be symmetrical with respect to a second reference plane, and a distance between the second reference plane and a top face of the case assembly may be equal to a distance between the second reference plane and a bottom face of the case assembly.

In exemplary embodiments, each of the first case and the second case may include: a main plate having a main plate bent part extending from one side thereof; and an auxiliary plate extending from the other side of the main plate and having an auxiliary plate bent part formed thereon, wherein a main plate of any one of the first and second cases may contact an auxiliary plate bent part of the other of the first and second cases.

In exemplary embodiments, each of the first and second cases may include: a bent part engaging protrusion protruding from the main plate bent part; and a bent part engaging hole formed through the auxiliary plate bent part, wherein a bent part engaging protrusion of any one of the first and second cases may be engaged with a bent part engaging hole of the other of the first and second cases.

In exemplary embodiments, the auxiliary plate bent part may extend with a step from the auxiliary plate.

In exemplary embodiments, the bent part engaging protrusion may extend from the main plate bent part toward the cell assembly in a shape that gradually narrows in width.

In exemplary embodiments, the bent part engaging protrusion may includes a trapezoidal shape.

A battery module according to various embodiments of the present disclosure may include: a case assembly extending in a front-back direction; and a cell assembly accommodated in the case assembly, wherein the case assembly may include a pair of main cases surrounding a peripheral portion of the cell assembly, and the pair of main cases may have the same shape.

In exemplary embodiments, the pair of main cases may be symmetrical with respect to the cell assembly.

In exemplary embodiments, the pair of main cases may include: a first case; and a second case coupled to the first case, wherein each of the first case and the second case may include a bent shape.

In exemplary embodiments, the cell assembly may include at least one battery cell, wherein at least one battery cell may be formed by stacking in a front-back direction.

In exemplary embodiments, each of the first case and the second case may have an L-shape.

In exemplary embodiments, each of the first case and the second case may have a C-shape.

In exemplary embodiments, the first case and the second case may be symmetrical with respect to a reference plane.

In exemplary embodiments, a peripheral portion of the case assembly may include a plurality of plates, and distances between each pair of facing plates among the plurality of plates and the reference plane may be equal.

The case assembly and battery module including the same according to one embodiment of the present disclosure may easily seat the cell assembly through a pair of cases having the same structure.

In addition, the case assembly and the battery module including the same according to the present disclosure may improve component manageability and assembly efficiency by enabling four-sided assembly with a single component.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is an exploded perspective view illustrating a battery module according to an exemplary embodiment of the present disclosure;

FIG. 2 is a perspective view illustrating first and second cases assembled according to an exemplary embodiment of the present disclosure;

FIG. 3 is a side view of the assembled first and second cases shown in FIG. 2;

FIG. 4 is a perspective view illustrating the first case according to an exemplary embodiment of the present disclosure;

FIG. 5 is a cross-sectional view taken along line A1-A2 of the assembly view shown in FIG. 2;

FIG. 6 is an enlarged view of area A of FIG. 5;

FIG. 7 is an enlarged view of area B of FIG. 5;

FIG. 8 is a view illustrating the first and second cases symmetrically arranged along a longitudinal direction of a battery cell according to an exemplary embodiment of the present disclosure; and

FIG. 9 is a view illustrating the first and second cases symmetrically arranged along a width direction of the battery cell according to an exemplary embodiment of the present disclosure.

### DETAILED DESCRIPTION OF THE INVENTION

The embodiments of the present disclosure are provided to more fully describe the present disclosure to those skilled in the art to which the present invention pertains. The following embodiments may be modified in various forms, and the scope of the present disclosure is not limited to these embodiments.

Hereinafter, some embodiments of the present disclosure will be described through exemplary drawings for the convenience of description. When assigning reference numerals to components of the respective drawings, it should be noted that the same components will be denoted by the same reference numerals, even if they appear in different drawings.

The terms or words used in this specification and the claims should not be construed as being limited to their conventional or lexical meanings, and instead, in accordance with the principle that an inventor may define the concepts of terms or words in the most appropriate manner to describe the invention, they should be interpreted based on the meanings and concepts that meet the technical spirit of the present disclosure.

The terms used herein are provided to describe specific embodiments and are not intended to limit the present disclosure. As used herein, the singular form may include the plural form unless the context clearly dictates otherwise.

In addition, when used to describe and define the present disclosure, terms such as “comprise,” “include,” “consist of,” and “have” should be interpreted in a nonexclusive manner. Unless explicitly stated otherwise, these terms should be construed to imply that the presence of the corresponding component, and not to exclude but rather include other components.

In addition, in describing components of the embodiment of the present disclosure, the terms such as first, second, A, B, (a), (b), and the like may be used. These terms are used to distinguish the component from other components and do not impose any limitations on their nature, sequence or order, etc.

It will be understood that when a component is described as being “connected” or “coupled” to another component, the component may be directly connected or coupled to the other component, but it may be “connected” or “coupled” to the other component with another component possibly interposed.

Space-related terms such as “beneath,” “below,” “lower,” “above,” and “upper” may be used to aid in the understanding of the relationship between an element or feature and another illustrated in the drawings. These space-related terms are provided to aid in the understanding of the present disclosure in various processing or usage states and are not intended to impose any limitations on the present disclosure. For example, if an element or feature in the drawing is turned upside down, the element or feature described as “beneath” or “below” becomes “above” or “upper.” Accordingly, the term “beneath” is a relative concept that may encompass “upper” as well as “below” depending on orientation.

The embodiments described in this specification and the configurations illustrated in the drawings merely represent the most preferred embodiments of the present disclosure but do not encompass all aspects of the technical spirit of the present disclosure. Thus, it should be understood that various modifications and equivalents may be implemented at the time of filing the present application. In addition, the publicly known functions and configurations that are deemed unnecessary for clarifying the essence of the present invention will not be described.

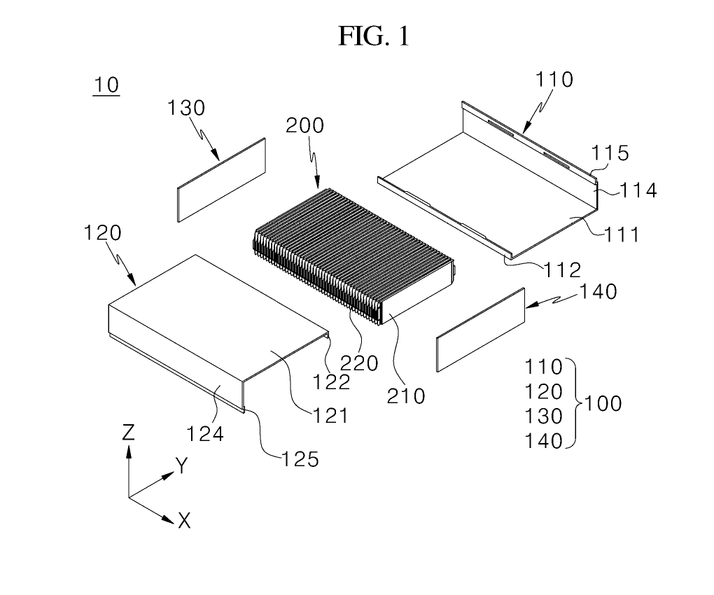

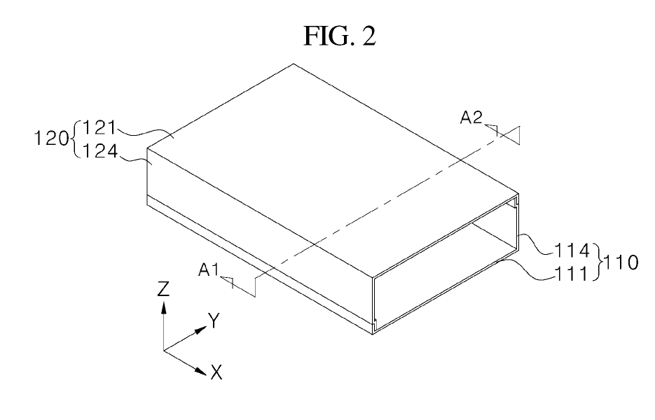

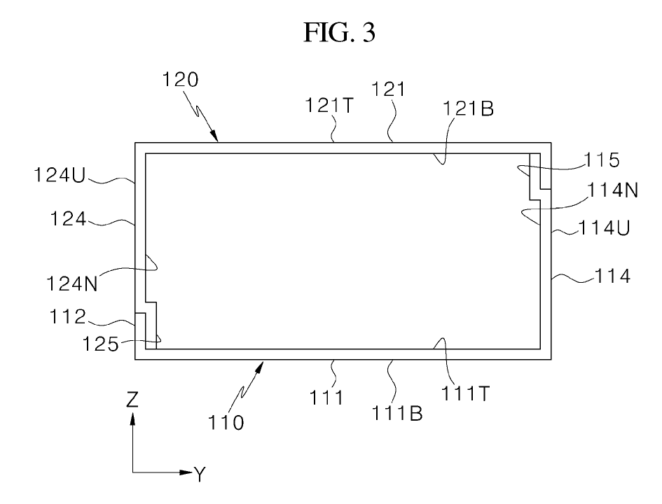

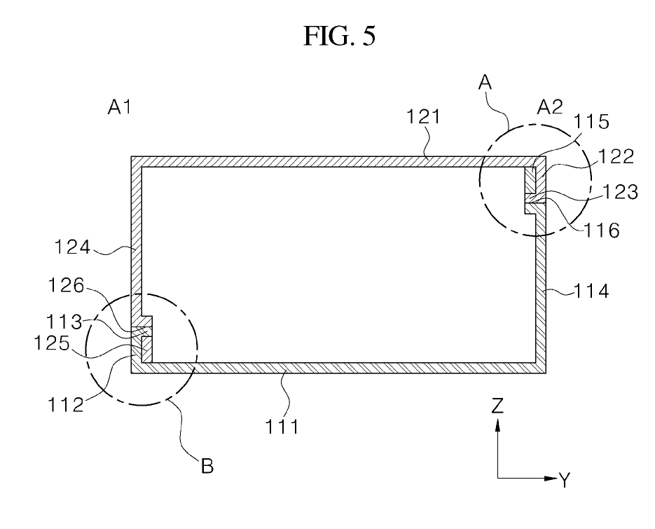

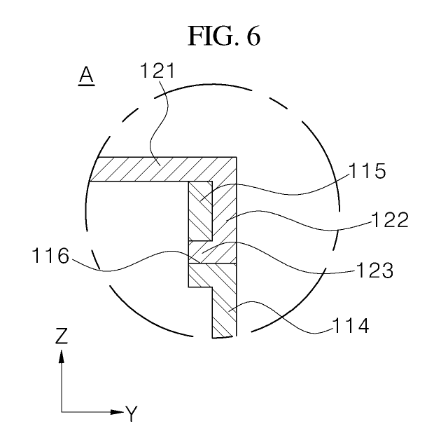

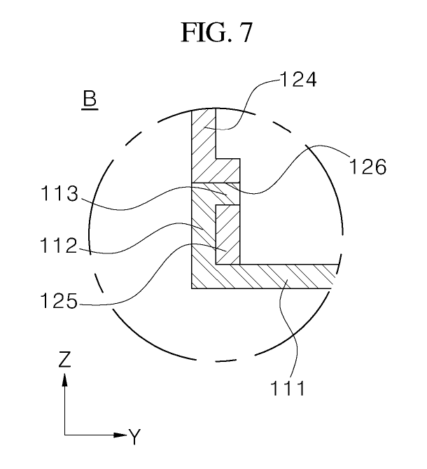

Hereinafter, case assembly and battery modules according to various embodiments of the present disclosure will be described in detail with reference to FIGS. 1 to 9.

The electrode assembly forming battery module of the present disclosure may be applied to pouch cells, cylindrical cells, prismatic cells, etc. The electrode assembly may be a winding type, a stacking type, a z-folding type, or a stacked-folding type.

In the present specification, the up-down, left-right, and front-back directions may be set based on FIG. 1.

The front-back direction may be parallel to the X-axis. For example, a positive X-axis direction may represent the frontward direction, and a negative X-axis direction may represent the rearward direction.

The up-down direction may be parallel to the Z-axis. For example, a positive Z-axis direction may represent the upward direction, and a negative Z-axis direction may represent the downward direction.

The left-right direction may be parallel to the Y axis. For example, a positive Y-axis direction may represent the right side, and a negative Y-axis direction may represent the left side. The Y-axis may be perpendicular to the X-axis and the Z-axis, respectively.

Referring to FIGS. 1 to 7, a battery module 10 may include a case assembly 100. The case assembly 100 may have a hollow shape. For example, the case assembly 100 may have a hollow hexahedral shape.

The case assembly 100 may extend in one direction. For example, the case assembly 100 may have an elongated shape in the front-back direction. For example, the case assembly 100 may extend along the longitudinal direction of the battery module 10. The longitudinal direction of the battery module 10 may be parallel to the front-back direction.

The battery module 10 may include a cell assembly 200. The cell assembly 200 may include at least one battery cell 210. The battery cell 210 may extend along the left-right direction. For example, the battery cell 210 may extend along a transverse direction of the battery module 10. The transverse direction of the battery module 10 may be parallel to the left-right direction.

The battery cells 210 may be stacked in one direction. The battery cells 210 may be stacked in the front-back direction. For example, the battery cells 210 may be stacked in the longitudinal direction of the battery module 10. A distance between two surfaces of the battery cells 210 may define a thickness of the battery cells 210. For example, the battery cells 210 may be stacked in a thickness direction of the battery cells 210.

The battery cell 210 may include a cell body 211 that accommodates an electrode assembly and an electrode lead 212 drawn out from the cell body 211.

The cell body 211 may form at least a portion of an exterior of the battery cell 210. The cell body 211 may include an electrode receiving part 2111 configured to accommodate an electrode assembly and a sealing part 2112 configured to seal at least a portion of a periphery of the electrode receiving part 2111. The electrode receiving part 2111 may be formed in a container shape. The electrode receiving part 2111 may provide a space for accommodating the electrode assembly and an electrolyte.

The sealing part 2112 may be formed by bonding at least a portion of the periphery of the cell body 211. The sealing part 2112 may be formed in a flange shape extending outward from the electrode receiving part 2111 formed in a container shape, and may be disposed along at least a portion of the outer periphery of the electrode receiving part 2111. The sealing part 2112 may be formed using a thermal-fusion method. However, the method of forming the sealing part 2112 is not limited thereto.

For example, the sealing part 2112 may include a first sealing part 2112a in which the electrode lead 212 is positioned and a second sealing part 2112b in which the electrode lead 212 is not positioned. A portion of the electrode lead 212 may be drawn out or exposed to the outside of the electrode receiving part 2111, which has a pouch shape.

At a position where the electrode lead 212 is drawn out, the electrode lead 212 may be arranged with being covered by an insulating film (not shown) to enhance the sealing of the first sealing part 2112a while ensuring an electrical insulation state. The insulating film may be formed in the form of a thin film of an insulating material and may be attached to both surfaces of the electrode lead 212.

The cell body 211 may be formed of a single sheet of outer material. For example, the cell body 211 may be formed by folding the outer material after one or two accommodation parts are formed on a single sheet of the outer material, and then the accommodation parts may provide a single space (e.g., the electrode receiving part).

For example, the electrode receiving part 2111 may be formed in a generally rectangular shape. The electrode receiving part 2111 may extend in the longitudinal direction and be formed in a generally rectangular shape. The sealing part 2112 may be formed by bonding the outer material to the outer periphery of the electrode receiving part 2111.

For example, the electrode leads 212 may be disposed on opposite sides of the battery cell 210 in the longitudinal direction. For example, the electrode lead 212 of a first polarity (e.g., a cathode) may be disposed on one side in the longitudinal direction of the battery cell 210, and another electrode lead 212 of a second polarity (e.g., an anode) may be disposed on the other side in the longitudinal direction.

However, this is merely illustrative, and the direction in which the electrode leads 212 are positioned may be arbitrarily designed. For example, the electrode leads 212 of the first and second polarities may be disposed together on either side in the longitudinal direction of the battery cell 210.

The cell assembly 200 may include cell pads 220. The cell pads 220 may be disposed between the battery cells 210. For example, the cell pads 220 may be spaced apart from each other in the longitudinal direction of the battery cell 210.

The case assembly 100 may include main cases 110 and 120. The main cases 110 and 120 may be disposed to surround a peripheral portion of the cell assembly 200. For example, the main cases 110 and 120 may form a peripheral portion of the battery module 10.

For example, the main cases 110 and 120 may include portions of the case assembly 100 excluding a front face and a rear face. For example, the main cases 110 and 120 may include a top face, a right lateral face, a bottom face, and a left lateral face of the case assembly 100.

The main cases 110 and 120 may include a pair of first and second cases 110 and 120. The pair of first and second cases 110 and 120 may be formed in corresponding shapes. For example, the pair of first and second cases 110 and 120 may be formed in the same shape.

The pair of first and second cases 110 and 120 may be disposed continuously along the peripheral portion of the cell assembly 200. For example, the pair of first and second cases 110 and 120 may be disposed sequentially along the peripheral portion of the cell assembly 200.

For example, the pair of first and second cases 110 and 120 may be symmetrically arranged with respect to the cell assembly 200. A virtual center line may be established that passes through a center of the cell assembly 200 and is parallel to the longitudinal direction of the cell assembly 200. For example, the pair of first and second cases 110 and 120 may be symmetrically arranged with respect to the virtual center line.

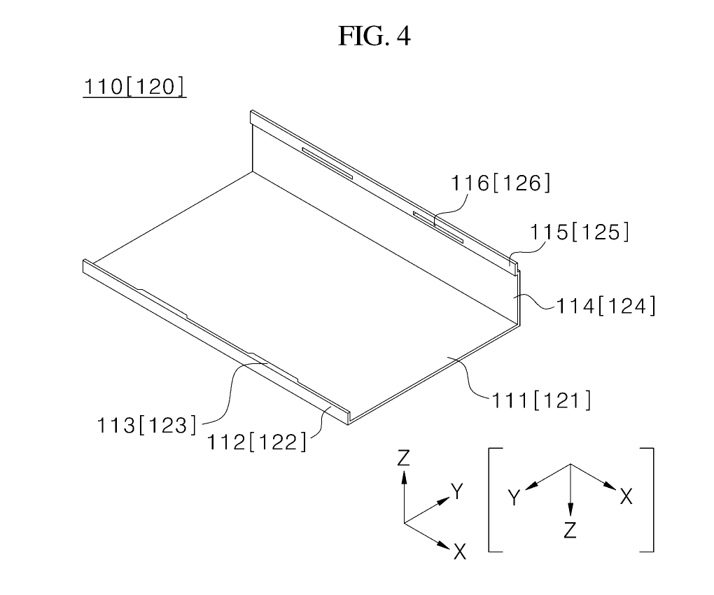

For example, referring to FIG. 4, the pair of first and second cases 110 and 120 may each form an overall L-shape. The pair of first and second cases 110 and 120 may have left-right and top-bottom symmetrical structures. For example, the first case 110 may have a structure that is open toward the left and upward. For example, the second case 120 may have a structure that is open toward the right and downward.

Each of the first and second cases 110 and 120 may be formed as a single unit. For example, each of the first and second cases 110 and 120 may be formed as a single member. For example, each of the first and second cases 110 and 120 may initially be formed as a flat member extending in one direction. The shape of each of the first and second cases 110 and 120 may be formed through processing of the flat member, such as pressing, bending, or punching.

By forming each of the first and second cases 110 and 120 as a single member, component manageability may be improved. In addition, the unified component shape may facilitate component quality and quantity management.

When assembling a case for the cell assembly 200, the number of required case components may be minimized. In other words, the number of components conventionally required, approximately six, may be reduced to four.

Furthermore, when assembling the cell assembly 200 and the case assembly 100, the number of welding points for case assembly may be minimized, thereby minimizing control points. Accordingly, mass production for battery module 10 assembly may be achieved.

As described above, the main cases 110 and 120, which have a pair of structures having the same shapes, may surround the peripheral portion of the cell assembly 200. With the cell assembly 200 seated in the first case 110, one of the main cases 110 and 120, the second case 120, the other of the main cases 110 and 120, may be coupled to the first case 110.

Accordingly, the number of case components required when assembling the case for the cell assembly 200 may be minimized. That is, the conventionally required six components may be reduced to four. In addition, by minimizing the number of welding points for case assembly, control points may be minimized.

The main cases 110 and 120 may include a first case 110. The first case 110 may be disposed on one side of the cell assembly 200. The first case 110 may be disposed to surround one lateral face of the cell assembly 200 and a bottom face of the cell assembly 200. For example, the first case 110 may be disposed to surround a right lateral face of the cell assembly 200 and the bottom face of the cell assembly 200.

The first case 110 may include a first main plate 111. The first main plate 111 may form a bottom face of the battery module 10. The first main plate 111 may include a first main plate top face part 111T.

The first main plate top face part 111T may face or be directed toward the interior of the battery module 10. For example, the first main plate top face part 111T may face or be directed toward the bottom face of the cell assembly 200.

The first main plate 111 may include a first main plate bottom face part 111B. The first main plate bottom face part 111B may face or be directed downward. A distance between the first main plate top face part 111T and the first main plate bottom face part 111B may define a thickness of the first main plate 111.

The first case 110 may include a first main plate bent part 112. The first main plate bent part 112 may be connected or coupled to the first main plate 111. The first main plate bent part 112 may be bent-formed on the first case 110.

For example, the first main plate bent part 112 may be formed to be orthogonal to the first main plate 111. For example, the first main plate bent part 112 may extend upward from an end of the first main plate 111.

The first case 110 may include a first bent part engaging protrusion 113. The first bent part engaging protrusion 113 may be formed on the first main plate bent part 112. For example, the first bent part engaging protrusion 113 may extend from the first main plate bent part 112 toward the interior of the battery module 10.

For example, the first bent part engaging protrusion 113 may extend in the width direction of the battery module 10. For example, the first bent part engaging protrusion 113 may extend in the longitudinal direction of the battery cell 210. For example, the first bent part engaging protrusion 113 may protrude toward the lateral face of the cell assembly 200.

A plurality of first bent part engaging protrusions 113 may be provided. For example, a pair of first bent part engaging protrusions 113 may be formed spaced apart from each other in the longitudinal direction of the battery module 10.

Each of the pair of first bent part engaging protrusions 113 may be formed in a trapezoidal shape. For example, each of the pair of first bent part engaging protrusions 113 may extend from the first main plate bent part 112 toward the cell assembly 200 in a shape that gradually narrows in width. For example, each of the pair of first bent part engaging protrusions 113 may extend away from an upper end of the first main plate bent part 112 toward the cell assembly 200.

The first bent part engaging protrusions 113 and the first main plate bent part 112 may share the same plane. For example, a top face of the first bent part engaging protrusion 113 may be at the same height as a top face of the first main plate bent part 112.

The first case 110 may include a first auxiliary plate 114. The first auxiliary plate 114 may form a right lateral face of the battery module 10. The first auxiliary plate 114 may include a first auxiliary plate inner face part 114N.

The first auxiliary plate inner face part 114N may face or be directed toward the interior of the battery module 10. For example, the first auxiliary plate inner face part 114N may face or be directed toward the right lateral face of the cell assembly 200.

The first auxiliary plate 114 may include a first auxiliary plate outer face part 114U. The first auxiliary plate outer face part 114U may face or be directed toward the right lateral face.

The first auxiliary plate 114 may be connected or coupled to the first main plate 111. The first auxiliary plate 114 may be bent-coupled to the first main plate 111. For example, the first auxiliary plate 114 and the first main plate 111 may be orthogonally coupled.

The first main plate top face part 111T may be connected to the first auxiliary plate inner face part 114N. The first main plate bottom face part 111B may be connected to the first auxiliary plate outer face part 114U.

The first case 110 may include a first auxiliary plate bent part 115. The first auxiliary plate bent part 115 may be connected or coupled to the first auxiliary plate 114. The first auxiliary plate bent part 115 may be bent-formed on the first auxiliary plate 114.

For example, the first auxiliary plate bent part 115 may be formed with a step on the first auxiliary plate 114. For example, the first auxiliary plate bent part 115 may be recessed into the battery module 10 from an end of the first auxiliary plate 114. For example, the step of the first auxiliary plate bent part 115 relative to the first auxiliary plate outer face part 114U may correspond to a thickness of the second main plate bent part 122.

The first auxiliary plate bent part 115 may be connected to one side of the cell assembly 200. For example, the first auxiliary plate bent part 115 may be connected to an upper right lateral face of the cell assembly 200. Accordingly, the position of the one side of the cell assembly 200 seated on the case assembly 100 may be fixed.

In addition, the stepped structure of the first auxiliary plate bent part 115 may secure a space between the first auxiliary plate 114 and the cell assembly 200. The space between the first auxiliary plate 114 and the cell assembly 200 may accommodate volume changes occurring in the cell assembly 200 and allow heat dissipation from the cell assembly 200.

For example, an outer face of the second main plate bent part 122 may be connected to the first auxiliary plate outer face part 114U. For example, an outer face of the second main plate bent part 122 and the first auxiliary plate outer face part 114U may form the right lateral face of the case assembly 100.

The first case 110 may include a first bent part engaging hole 116. The first bent part engaging hole 116 may be formed in the first auxiliary plate bent part 115. The first bent part engaging hole 116 may be formed through the inner and outer faces of the first auxiliary plate bent part 115. The first bent part engaging hole 116 may extend in the longitudinal direction of the battery module 10.

A plurality of first bent part engaging holes 116 may be provided. For example, a pair of first bent part engaging holes 116 may be spaced apart from each other in the longitudinal direction of the battery module 10. Each of the pair of first bent part engaging holes 116 may be coupled to each of a corresponding pair of second bent part engaging protrusions 123. For example, each pair of second bent part engaging protrusions 123 may be individually coupled to each of the pair of first bent part engaging holes 116.

The coupling structure between the second bent part engaging protrusion 123 and the first bent part engaging hole 116 may eliminate a need for a separate fastening means conventionally required. In other words, processes such as bolting or welding, which were conventionally required in the case coupling process, may be omitted. Accordingly, the case assembly process may be simplified.

The main cases 110 and 120 may include a second case 120. The second case 120 may be disposed on the other side of the cell assembly 200. The second case 120 may be disposed to surround the other lateral face of the cell assembly 200 and a top face of the cell assembly 200. For example, the second case 120 may be disposed to surround the right lateral face of the cell assembly 200 and the top face of the cell assembly 200.

The second case 120 may include a second main plate 121. The second main plate 121 may form the top face of the battery module 10. The second main plate 121 may include a second main plate bottom face part 121B.

The second main plate bottom face part 121B may face or be directed toward the interior of the battery module 10. For example, the second main plate bottom face part 121B may face or be directed toward the top face of the cell assembly 200.

The second main plate 121 may include a second main plate top face part 121T. The second main plate top face part 121T may face or be directed upward. A distance between the second main plate bottom face part 121B and the second main plate top face part 121T may define a thickness of the second main plate 121.

The second case 120 may include a second main plate bent part 122. The second main plate bent part 122 may be connected or coupled to the second main plate 121. The second main plate bent part 122 may be bent-formed on the second main plate 121.

For example, the second main plate bent part 122 may be formed to be orthogonal to the second main plate 121. For example, the second main plate bent part 122 may extend downward from an end of the second main plate 121.

The second case 120 may include a second bent part engaging protrusion 123. The second bent part engaging protrusion 123 may be formed on the second main plate bent part 122. For example, the second bent part engaging protrusion 123 may extend from the second main plate bent part 122 toward the interior of the battery module 10. For example, the second bent part engaging protrusion 123 may be formed to protrude toward the lateral face of the cell assembly 200.

The second bent part engaging protrusion 123 and the second main plate bent part 122 may share the same plane. For example, a bottom face of the second bent part engaging protrusion 123 may be at the same height as a bottom face of the second main plate bent part 122.

The second case 120 may include a second auxiliary plate 124. The second auxiliary plate 124 may form a left lateral face of the battery module 10. The second auxiliary plate 124 may be connected or coupled to the second main plate 121. For example, the second auxiliary plate 124 may extend downward from a side end of the second main plate 121.

The second auxiliary plate 124 may be bent-coupled to the second main plate 121. For example, the second auxiliary plate 124 and the second main plate 121 may be coupled so as to be orthogonal to each other.

The second auxiliary plate 124 may include a second auxiliary plate inner face part 124N. The second auxiliary plate inner face part 124N may face or be directed toward the interior of the battery module 10.

For example, the second auxiliary plate inner face part 124N may face or be directed toward a left lateral face of the cell assembly 200. The second auxiliary plate 124 may include the second auxiliary plate outer face part 124U. The second auxiliary plate outer face part 124U may face or be directed toward the left lateral face.

The second main plate bottom face part 121B may be connected to the second auxiliary plate inner face part 124N. The second main plate top face part 121T may be connected to the second auxiliary plate outer face part 124U.

The second case 120 may include a second auxiliary plate bent part 125. The second auxiliary plate bent part 125 may be connected or coupled to the second auxiliary plate 124. The second auxiliary plate bent part 125 may be bent-formed on the second auxiliary plate 124.

For example, the second auxiliary plate bent part 125 may be formed with a step on the second auxiliary plate 124. For example, the second auxiliary plate bent part 125 may be recessed into the battery module 10 from an end of the second auxiliary plate 124. For example, the step of the second auxiliary plate bent part 125 relative to the second auxiliary plate outer face part 124U may correspond to a thickness of the first main plate bent part 112.

The second auxiliary plate bent part 125 may be connected to the other side of the cell assembly 200. For example, the second auxiliary plate bent part 125 may be connected to a lower left lateral face of the cell assembly 200. Accordingly, the position of the other side of the cell assembly 200 seated on the case assembly 100 may be fixed.

In addition, the stepped structure of the second auxiliary plate bent part 125 may secure a space between the second auxiliary plate 124 and the cell assembly 200. The space between the second auxiliary plate 124 and the cell assembly 200 may accommodate volume changes occurring in the cell assembly 200 and allow heat dissipation from the cell assembly 200.

An outer face of the first main plate bent part 112 may be connected to the second auxiliary plate outer face part 124U. For example, an outer face of the first main plate bent part 112 and the second auxiliary plate outer face part 124U may form the left lateral face of the case assembly 100.

The first auxiliary plate bent part 115 formed with the step on the first auxiliary plate 114 and the second auxiliary plate bent part 125 formed with the step on the second auxiliary plate 124 may be positioned at corners of the case assembly 100. For example, the first auxiliary plate bent part 115 and the second auxiliary plate bent part 125 may be disposed diagonally in the case assembly 100.

Since the first auxiliary plate bent part 115 and the second auxiliary plate bent part 125 are arranged at edges of the case assembly 100, the structural stability of the case assembly 100 may be enhanced.

The second case 120 may include a second bent part engaging hole 126. The second bent part engaging hole 126 may be formed in the second auxiliary plate bent part 125. The second bent part engaging hole 126 may be formed through the inner and outer faces of the second auxiliary plate bent part 125. The second bent part engaging hole 126 may extend in the longitudinal direction of the battery module 10.

A plurality of second bent part engaging holes 126 may be provided. For example, a pair of second bent part engaging holes 126 may be spaced apart from each other in the longitudinal direction of the battery module 10. Each of the pair of second bent part engaging holes 126 may be coupled to each of a corresponding pair of first bent part engaging protrusions 113. For example, each of the pair of first bent part engaging protrusions 113 may be individually coupled to each of the pair of second bent part engaging holes 126.

The coupling structure between the first bent part engaging protrusion 113 and the second bent part engaging hole 126 may eliminate a need for a separate fastening means conventionally required. In other words, processes such as bolting or welding, which were conventionally required in the case coupling process, may be omitted. Accordingly, the case assembly process may be simplified.

Referring to FIG. 1, the case assembly 100 may include a rear case 130. The rear case 130 may form a rear face of the battery module 10. The rear case 130 may be positioned on a rear face of the cell assembly 200. The rear case 130 may be coupled to the main cases 110 and 120.

The case assembly 100 may include a front case 140. The front case 140 may form a front face of the battery module 10. The front case 140 may be positioned on a front face of the cell assembly 200. The front case 140 may be coupled to the main cases 110 and 120.

The rear case 130 and the front case 140 may be spaced apart from each other in the longitudinal direction of the battery module 10. For example, the cell assembly 200 may be disposed between the rear case 130 and the front case 140.

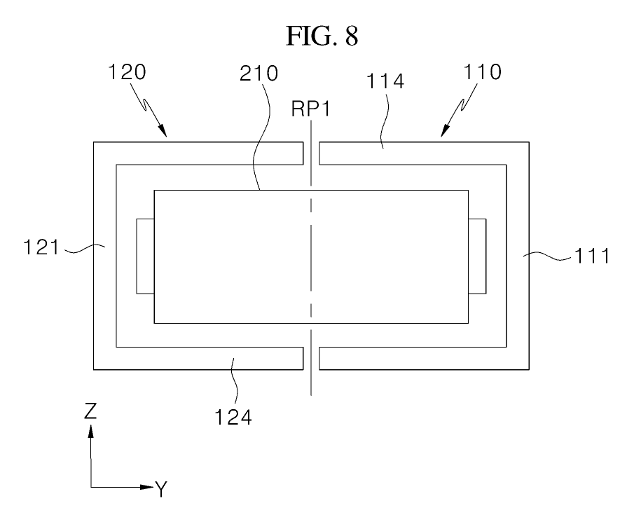

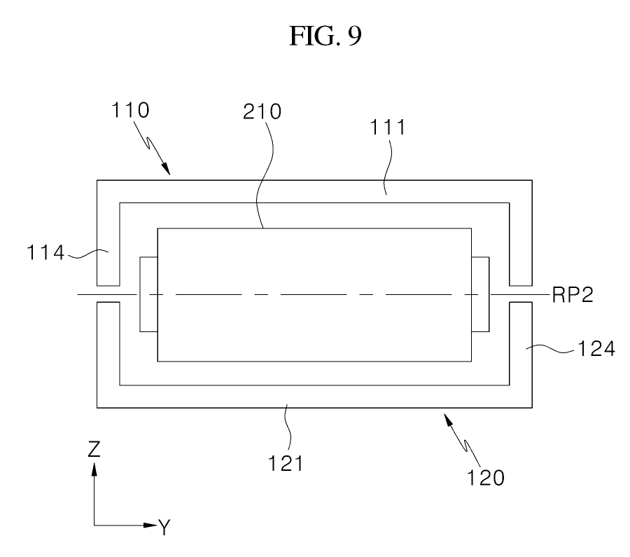

FIGS. 8 and 9 illustrate a state in which the first and second cases 110 and 120 are disposed to face each other in a specific direction of the battery cell 210.

Referring to FIG. 8, the main cases 110 and 120 are disposed to face each other in the longitudinal direction of the battery cell 210. For example, the first case 110 may surround one side of the battery cell 210, and the second case 120 may surround the other side of the battery cell 210 in the longitudinal direction of the battery cell 210.

For example, the first case 110 and the second case 120 may be symmetrical with respect to a first reference plane RP1. A distance between the first reference plane RP1 and the left lateral face of the case assembly 100 may be equal to a distance between the first reference plane RP1 and the right lateral face of the case assembly 100. The first reference plane RP1 may be a virtual reference plane set in the case assembly 100.

For example, the first reference plane RP1 may be parallel to the front-back direction. The first reference plane RP1 may be parallel to the longitudinal direction of the case assembly 100. The first reference plane RP1 may be parallel to the stacking direction of the battery cells 210.

Meanwhile for another example, the first reference plane RP1 may be parallel to the vertical direction. The first reference plane RP1 may be parallel to the height direction of the case assembly 100. The first reference plane RP1 may be parallel to the width direction of the battery cells 210.

For example, each of the first and second cases 110 and 120 may have a shape that is open on one side. For example, each of the first and second cases 110 and 120 may form a C-shaped structure. This allows the first case 110 and the second case 120 to easily accommodate the stacked battery cells 210 along the left-right direction.

For example, after one side of the stacked battery cells 210 is initially coupled to the first case 110, the other side of the stacked battery cells 210 may be secondarily coupled to the second case 120, thereby improving assembly workability. Meanwhile, both sides of the stacked battery cells 210 may be simultaneously coupled to the first case 110 and the second case 120.

Referring to FIG. 9, the main cases 110 and 120 are disposed to face each other in the width direction of the battery cells 210. For example, along the width direction of the battery cells 210, the first case 110 may be structured to surround one side of the battery cells 210, and the second case 120 may be structured to surround the other side of the battery cells 210.

For example, the first case 110 and the second case 120 may be symmetrical with respect to a second reference plane RP2. A distance between the second reference plane RP2 and the top face of the case assembly 100 may be equal to a distance between the second reference plane RP2 and the bottom face of the case assembly 100. The second reference plane RP2 may be a virtual reference plane set in the case assembly 100.

The first case 110 and the second case 120 may be symmetrical with respect to the first reference plane RP1 or the second reference plane RP2. The peripheral portion of the case assembly 100 may include a plurality of plates 111, 114, 121, and 124. A distance between each pair of facing plates among the plurality of plates 111, 114, 121, and 124 and the reference planes RP1 and RP2 may be equal. For example, a distance between the first main plate 111 and the first reference plane RP1 may be the same as a distance between the second main plate 121 and the first reference plane RP1. For example, a distance between the first main plate 111 and the second reference plane RP2 may be the same as a distance between the second main plate 121 and the second reference plane RP2.

For example, the second reference plane RP2 may be parallel to the front-back direction. The second reference plane RP2 may be parallel to the longitudinal direction of the case assembly 100. The second reference plane RP2 may be parallel to the stacking direction of the battery cell 210.

Meanwhile for another example, the second reference plane RP2 may be parallel to the left-right direction. The second reference plane RP2 may be parallel to the transverse direction of the case assembly 100. The second reference plane RP2 may be parallel to the longitudinal direction of the battery cell 210.

For example, each of the pair of first and second cases 110 and 120 may have a shape that is open on one side. For example, each of the pair of first and second cases 110 and 120 may form a C-shaped structure.

This allows the first case 110 and the second case 120 to easily accommodate the stacked battery cells 210 along the front-back direction. For example, after a bottom side of the stacked battery cells 210 is initially coupled to the second case 120, a top side of the stacked battery cells 210 may be secondarily coupled to the first case 110, thereby improving assembly workability. Meanwhile, the top and bottom sides of the stacked battery cells 210 may be simultaneously coupled to the first case 110 and the second case 120.

While the case assembly and battery module according to the embodiments of the present disclosure have been described as specific embodiments, these are merely examples, and the present disclosure is not limited thereto, and should be construed to have the broadest possible scope consistent with the basic concepts disclosed herein.

What is claimed is:

1. A case assembly configured to accommodate a cell assembly, the case assembly comprising:
a pair of main cases forming a peripheral portion of the case assembly;
a front case forming a front face of the case assembly; and
a rear case forming a rear face of the case assembly,
wherein the pair of main cases have the same shape.

2. The case assembly according to claim 1, wherein the pair of main cases comprise:
a first case; and
a second case coupled to the first case,
wherein the first case and the second case are symmetrical with respect to the cell assembly.

3. The case assembly according to claim 2, wherein each of the first case and the second case includes a bent shape.

4. The case assembly according to claim 3, wherein each of the first case and the second case has an L-shape.

5. The case assembly according to claim 3, wherein each of the first case and the second case has a C-shape.

6. The case assembly according to claim 5, wherein the first case and the second case are symmetrical with respect to a first reference plane, and
a distance between the first reference plane and a left lateral face of the case assembly is equal to a distance between the first reference plane and a right lateral face of the case assembly.

7. The case assembly according to claim 5, wherein the first case and the second case are symmetrical with respect to a second reference plane, and
a distance between the second reference plane and a top face of the case assembly is equal to a distance between the second reference plane and a bottom face of the case assembly.

8. The case assembly according to claim 4, wherein each of the first case and the second case comprises:
a main plate having a main plate bent part extending from one side thereof; and
an auxiliary plate extending from the other side of the main plate and having an auxiliary plate bent part formed thereon, and
wherein a main plate of any one of the first and second cases contacts an auxiliary plate bent part of the other of the first and second cases.

9. The case assembly according to claim 8, wherein each of the first case and the second case comprises:
a bent part engaging protrusion protruding from the main plate bent part; and
a bent part engaging hole formed through the auxiliary plate bent part, and
wherein a bent part engaging protrusion of any one of the first and second cases is engaged with a bent part engaging hole of the other of the first and second cases.

10. The case assembly according to claim 8, wherein the auxiliary plate bent part extends with a step from the auxiliary plate.

11. The case assembly according to claim 9, wherein the bent part engaging protrusion extends from the main plate bent part toward the cell assembly in a shape that gradually narrows in width.

12. The case assembly according to claim 11, wherein the bent part engaging protrusion includes a trapezoidal shape.

13. A battery module comprising:
a case assembly extending in a front-back direction; and
a cell assembly accommodated in the case assembly,
wherein the case assembly comprises a pair of main cases surrounding a peripheral portion of the cell assembly, and
the pair of main cases have the same shape.

14. The battery module according to claim 13, wherein the pair of main cases are symmetrical with respect to the cell assembly.

15. The battery module according to claim 14, wherein the pair of main cases comprises:
a first case; and
a second case coupled to the first case, and
wherein each of the first case and the second case includes a bent shape.

16. The battery module according to claim 15, wherein the cell assembly comprises at least one battery cell, and
wherein at least one battery cell is formed by stacking in the front-back direction.

17. The battery module according to claim 16, wherein each of the first case and the second case has an L-shape.

18. The battery module according to claim 16, wherein each of the first case and the second case has a C-shape.

19. The battery module according to claim 15, wherein the first case and the second case are symmetrical with respect to a reference plane.

20. The battery module according to claim 13, wherein a peripheral portion of the case assembly includes a plurality of plates, and
distances between each pair of facing plates among the plurality of plates and the reference plane are equal.
